(19) United States
(12) Patent Application Publication
(10) Pub. No.: US 2018/0188055 A1
(43) Pub. Date: Jul. 5, 2018

(54) METHOD FOR VEHICULAR NAVIGATION USING STATIC, REAL-TIME AND PREDICTIVE DATA

(71) Applicant: Adam Benjamin Tannenbaum, Ashdod (IL)

(72) Inventor: Adam Benjamin Tannenbaum, Ashdod (IL)

(21) Appl. No.: 15/397,858

(22) Filed: Jan. 4, 2017

(51) Int. Cl. G01C 21/34; G08G 1/0969

(52) U.S. Cl. CPC G01C 21/3492; G08G 1/0969

(57) ABSTRACT

The invention is a method of vehicular navigation using static, real-time, historical, environmental and predictive route and road-condition data.

### TECHNICAL FIELD

The present invention relates to vehicular navigation systems.

### BACKGROUND OF THE INVENTION

GPS-based vehicular navigation systems were introduced in 1990. Since then, there have been significant improvements in position determination and mapping data. The original GPS system made use of GPS satellite signals to determine a vehicle's mapping coordinates and these were then correlated with static mapping data to indicate a vehicle's map location. Using destination input data, and static map data, a navigation system could plot out a route from current vehicle position to destination and provide a driver with step-by-step routing instructions. In that system manifestation, route planning was based on current location and historical map data. There was no way to incorporate real-time events, such as accidents or lane obstructions, into the routing processing to avoid delays. Real-time data, as reported by traffic regulatory authorities and drivers, were later added to the static data to enable a driver to understand why traffic was delayed and to get some idea of the delay extent. In some cases, the real-time data would enable a navigation system to plot an alternative route to circumvent a delay. Overall this improvement provided more information and could reduce destination arrival time delays. However, neither the static system nor the static-plus-real-time-event system incorporated disseminated road maintenance scheduling or traffic-causing scheduled events. For example, municipalities typically publish roadwork scheduling and traffic-causing events are often publicized well in advance of such events.

### BRIEF SUMMARY OF THE INVENTION

A navigation system that incorporates static mapping data, real-time event data, and predictive scheduling data could improve system routing decisions by making routing decisions that circumvent predictable roadwork, public events, and the like, all of which can cause delays.

The method herein disclosed and claimed blends static mapping data, real-time event data and both personal and public scheduling data so as to improve the efficiency of a vehicular navigation system by enabling it to alter routing decisions based on predictable delays and real-time event delays.

### BRIEF DESCRIPTIONS OF THE DRAWINGS

FIG. 1 depicts a vehicle equipped with a navigation system and making use of static data and GPS positioning data.

FIG. 2 depicts a block diagram of the subsystems comprising the navigation system of the vehicle in FIG. 1.

FIG. 3 depicts a flow diagram showing how GPS data and destination data are used to produce a route output.

FIG. 4 depicts a vehicle equipped with a navigation system making use of static data, real-time data, and GPS positioning data.

FIG. 5 depicts the subsystems making up the navigation system of FIG. 4 plus the inclusion of a mobile device and application for providing the real-time event data.

FIG. 6 depicts a flow diagram showing how GPS data and destination data are used to produce a route output which includes real-time route data that may conditionally affect the route output result.

FIG. 7 depicts a vehicle equipped with a navigation system that uses static data, real-time data, plus predictive scheduling data.

FIG. 8 depicts the subsystems making up the navigation system of FIG. 7.

FIG. 9 depicts a flow diagram showing how GPS data and destination data are used to produce a route output which includes real-time route data and predictive scheduling data that may conditionally affect the route output result.

### DETAILED DESCRIPTION OF THE INVENTION

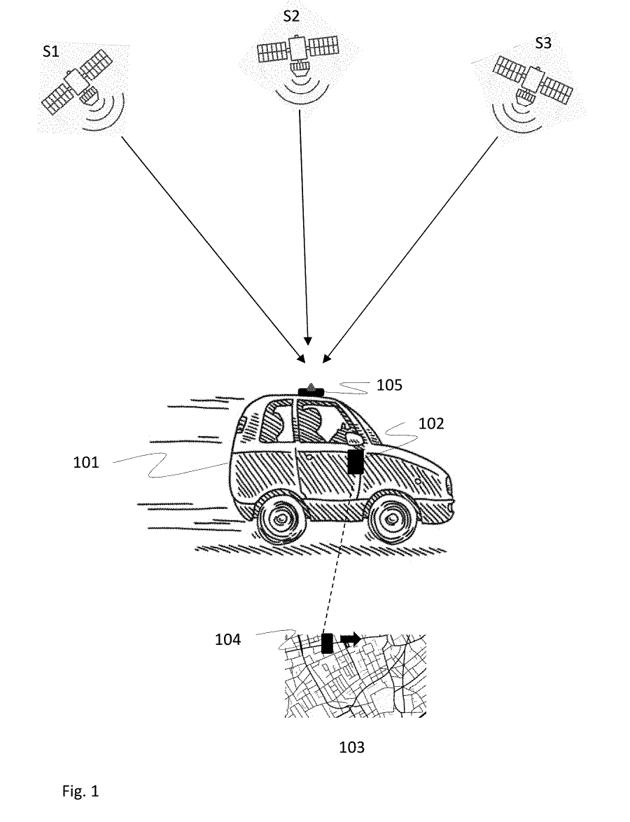

A typical vehicular navigation system (FIG. 1) makes use of mapping data and vehicle (101) position data to plot out a suggested route for going from a current position to the destination location. Vehicle position is determined using GPS technology. That is, multiple GPS satellite signals are received by the vehicle's antenna (105) and GPS receiver. Making use of current position as determined by the GPS technology and destination coordinate data, the navigation system plots out a route which may be displayed on a navigation system's I/O display (103) and may be augmented by voice synthesis-generated step-by-step routing instructions. Usually, the display shows the vehicle's current position and traveling direction superimposed on a map. The navigation system (102) may contain the GPS receiver, a storage subsystem containing pertinent mapping data, a navigation and routing processor, and an I/O subsystem for display and input. The GPS satellites, depicted as S1, S2 and S3 are exemplary. That is, a GPS system ordinarily requires at least three satellite signals to provide accurate positioning data. During brief periods where one or more satellites' signals are blocked, the system will usually continue to operate, using interpolation, until the requisite number of satellites is again in view.

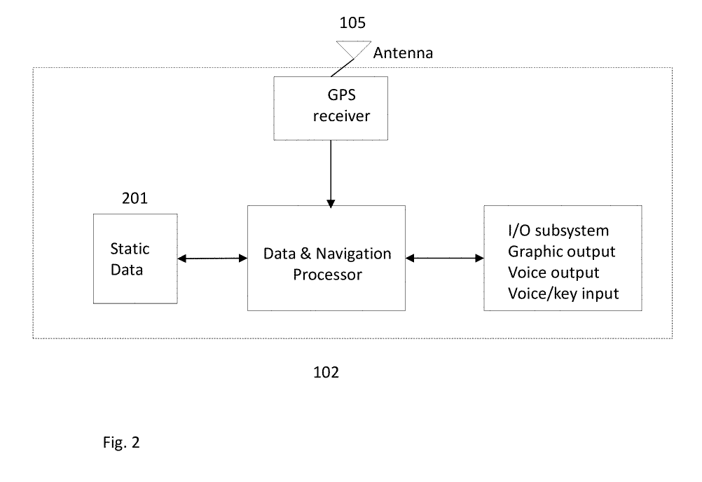

FIG. 2 shows a block diagram of an exemplary navigation system comprising the subsystems for static data storing and dissemination, data and navigation processing, the GPS receiving subsystem, and an I/O subsystem operative to provide a user with visual and auditory output as well as a means of inputting destination data and route preferences, such as “toll free,” “fastest,” “shortest,” and the like. The subsystems may all be contained within a single enclosure, or the subsystems may be two or more separate entities that are interconnected so as to convey data among them.

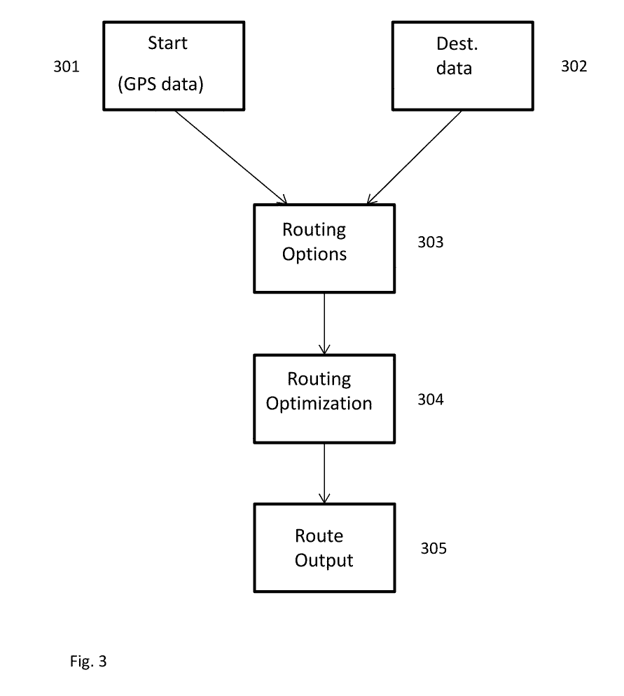

FIG. 3 shows a flow diagram beginning with GPS “start” data (301) and destination data (302). Destination data may be keyed in using an I/O subsystem or may be input using voice recognition technology. Once the GPS and destination data is entered, the navigation system will perform a routing options procedure (303) followed by routing optimization (304) and finally produce a route output (305). Routing options may include toll and/or toll free choices, and faster versus longer routing choices. If users have input route preferences, the routing optimization will use those preferences to conditionally optimize the route choices.

A navigation system such as the one shown in FIGS. 1, 2 and 3 provides a routing output typically unaffected by date, time of day, or real-time road conditions. As such, one may end up following a route into a huge traffic bottleneck.

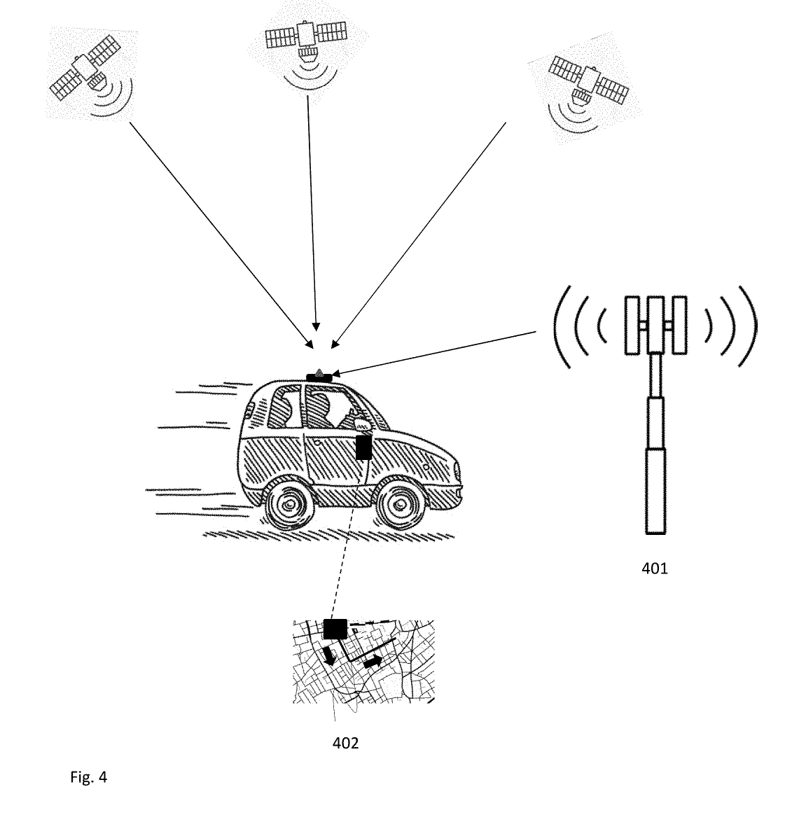

FIG. 4 shows a more recent innovation in which the system of FIG. 1 is augmented by additional technology and processing resources allowing real-time event data to be incorporated in the route result information. For example, an accident or stalled vehicle that is blocking a traffic lane may be reported by traffic safety authorities and/or other drivers using a common application that enables the navigation system to, at a minimum, explain what is causing a delay and, at best, to offer alternative routing solutions that may circumvent a delay. As shown in FIG. 4, a cell-phone tower (401) or WiFi link (not shown) could be used to convey real-time road circumstances allowing the navigation system to plot an alternative route (402).

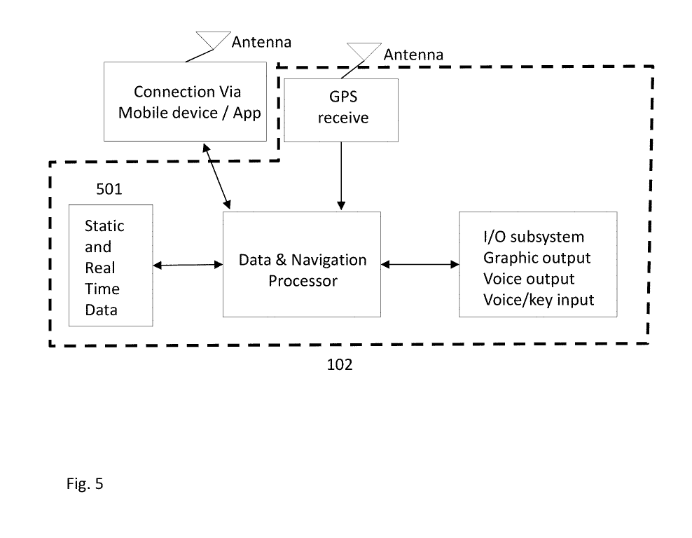

FIG. 5 shows an exemplary navigation system and its subsystems and includes a connection via a mobile device and application that provides the real-time data. Now, the data storage and dissemination subsystem (501) contains both static data (i.e. mapping data) and real-time data. As shown, the mobile device is separate from the navigation system subsystems but it is only one example. A navigation system could include the mobile device and application within the same navigation system.

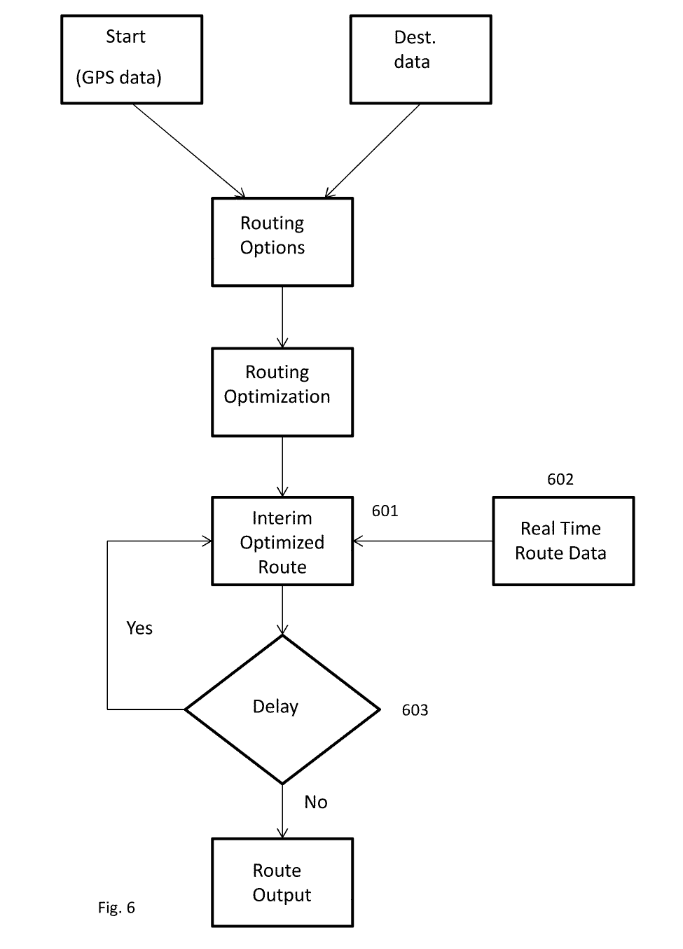

FIG. 6 shows a flow diagram similar to that of FIG. 3 whereby start data and destination data precede routing options and routing optimization. However, an additional procedure includes interim optimized routing (601) and incorporation of real-time route data (602). Conditionally (603), the real-time data may alter the route output result. For example, if real-time data indicates a lane or lanes blockage due to an accident that is located after an upcoming exit, the interim optimized routing process may direct the driver to exit and circumvent the blockage rather than being caught in the ensuing delay.

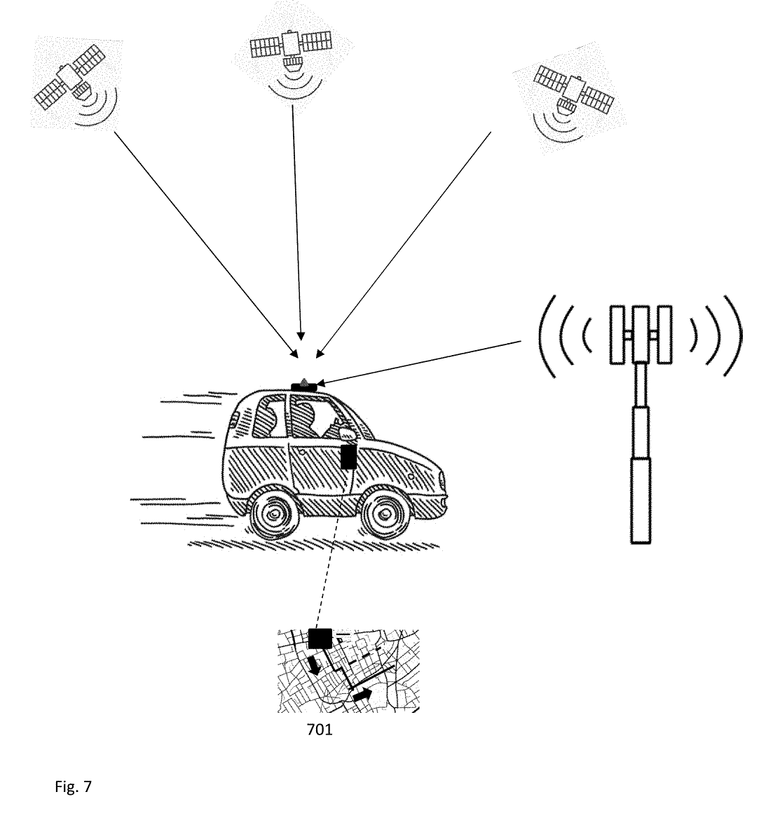

In FIG. 7, the vehicular navigation system of FIG. 4 is now augmented by inclusion of personal and public scheduling data in addition to static and real-time data. As a result of, say, scheduled road maintenance, the navigation system may provide alternative routing based on predictable rather than real-time delay. Similarly, the publicized schedule of an event at a stadium that empties into the original route may prompt the system to find an alternative route that avoids the predictable traffic bottleneck. In addition to the public and personal data, historical and environmental data related to road conditions under different circumstances could also be included. As such, for example, if a route historically has flooded under moderate rain that data would be included and could affect the route choice if current weather predicts moderate rain. Similarly, if recurring events result in markedly increased traffic volume, that historical data could affect route choice if that recurring event is concurrent with a navigation request.

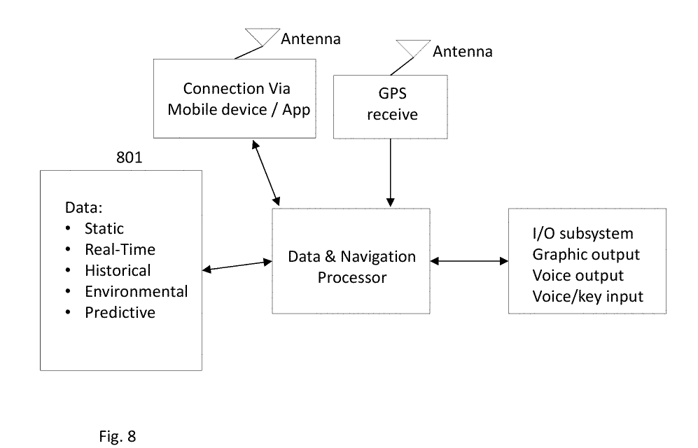

FIG. 8 shows that now the data storage and dissemination subsystem (801) contains static, real-time, and predictive (i.e. personal and/or public scheduling data, historical and environmental route data) data.

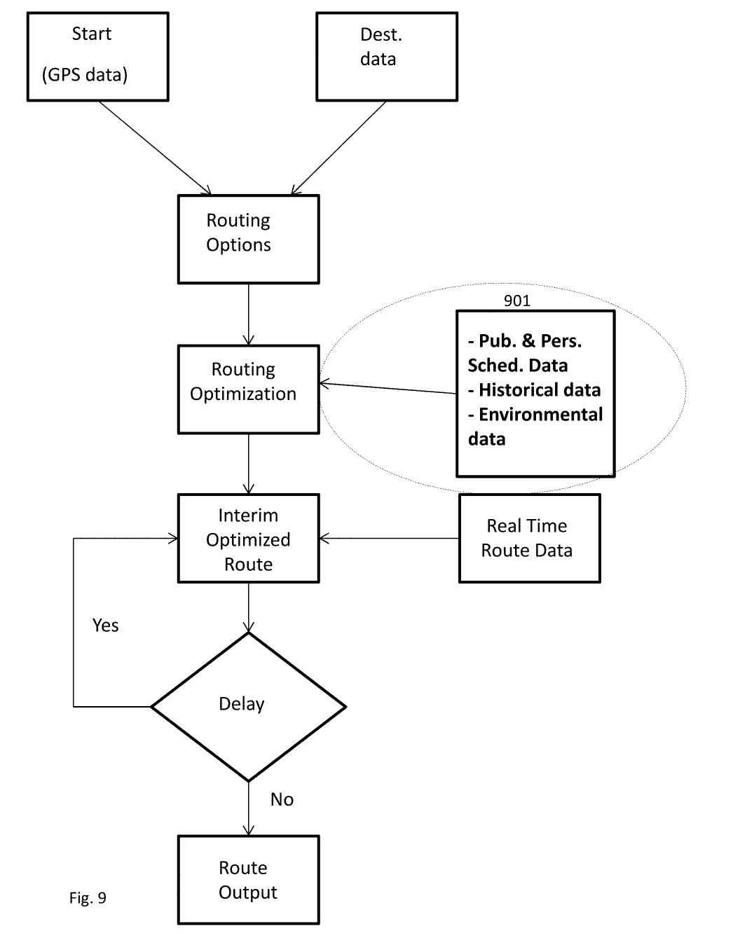

As shown in FIG. 9, the public/personal scheduling data, and historical and environmental data, becomes an input (901) to the routing optimization procedure in advance of real-time-influenced interim optimized route processing. As such, the inclusion of the predictive data (901) may preemptively alter the routing recommendation so as to avoid predictable delays. This could avoid the situation where a driver is essentially trapped on a highway with traffic at a standstill because an event's attendees are flooding onto the route from an exit up ahead. Real-time events may explain the delay but predictive route alternation may avoid it all together.

A mobile device application could be used to provide both real-time and predictive data. Thus, the hardware associated with FIG. 7 could be essentially the same as that of FIG. 4. The distinctiveness arises in the procedural flow as shown in FIG. 9. By including predictive data, and using it to modify routing results, preemptively, one may avoid significant delays.

A system intended for use with this method could be more versatile than a contemporary navigation system in that it remembers the vehicle's last location and/or the location can be keyed in or spoken by the user. That would enable the system to function, initially, in the absence of a GPS location. Thus, such a system could be started using any of three procedures: last-location memory, user location input, and/or GPS location determination. In addition, said system could be designed to provide step by step navigation (just as if it were connected to GPS) when no GPS is available or connected. This is done by using sensors, maps, compass and the longitude and latitude information of where the vehicle is at now and where it is going.

What is claimed is:

1. A method comprising:
determining a vehicle's current position from signals received by said vehicle from at least GPS satellite;
plotting a route based on said vehicle's current position and a specified destination and its coordinates;
refining said route based on specified route preferences;
further refining said route based on said specified route preferences by using data based on personal and public scheduling, and historical and environmental route issues.

2. A method as in claim 1 further comprising:
further refining said route based on said specified route preferences, and said personal and public scheduling, and historical and environmental route issues by using real-time data of traffic conditions on said further refined said route based on said specified route preferences, and said personal and public scheduling, and historical and environmental route issues.

3. A method as in claim 1 further comprising:
presenting said further refined said route based on said specified route preferences and said data based on personal and public scheduling and historical and environmental route issues to a user using a visual display.

4. A method as in claim 1 further comprising:
presenting said further refined said route based on said specified route preferences and said data based on personal and public scheduling, and historical and environmental route issues to a user using said visual display and voice synthesis.

5. A method as in claim 2 further comprising:
presenting said further refined said route based on said specified route preferences and said data based on personal and public scheduling, and historical route and environmental issues plus said real-time data of traffic conditions to a user using a visual display.

6. A method as in claim 2 further comprising:
presenting said further refined said route based on said specified route preferences and said data based on personal and public scheduling, and historical and environmental route issues plus said real-time data of traffic conditions to a user using said visual display and voice synthesis.
